(19) United States
(12) Patent Application Publication
(10) Pub. No.: US 2020/0363213 A1
(43) Pub. Date: Nov. 19, 2020

(54) LOCALIZATION SYSTEM, TRANSPORTATION DEVICE HAVING THE SAME, AND COMPUTING DEVICE

(71) Applicant: Polaris3D Co., Ltd., Gyeongsangbuk-do (KR)

(72) Inventors: Chi Won SUNG, Gyeongsangbuk-do (KR); Ho Yong LEE, Gyeongsangbuk-do (KR); In Veom KWAK, Gyeongsangbuk-do (KR)

(21) Appl. No.: 16/850,312

(22) Filed: Apr. 16, 2020

(30) Foreign Application Priority Data
May 15, 2019 (KR) 10-2019-0057019

(51) Int. Cl. G01C 21/30; G06K 9/00; G01C 21/16

(52) U.S. Cl. CPC G01C 21/30; G01C 21/165; G06K 9/00208; G06K 9/00791

(57) ABSTRACT

A localization system is installed in a transportation device and includes an inertial measurement device configured to generate inertial data by measuring inertia resulting from movement of the transportation device when the transportation device moves, an imaging device configured to generate captured images by photographing surroundings of the transportation device when the transportation device moves, and a location analysis device configured to measure a moved location of the transportation device on the basis of the inertial data and at least one of the captured images.

### CROSS-REFERENCE TO RELATED APPLICATION

This application claims priority to and the benefit of Korean Patent Application No. 10-2019-0057019, filed on May 15, 2019, the disclosure of which is incorporated herein by reference in its entirety.

### BACKGROUND

### 1. Field

Embodiments of the present disclosure relate to a localization technology.

### 2. Discussion of Related Art

Recently, along with the development of robot technology, factories are being automated, and mobile robots are also being developed. Mobile robots are programmed to move to a destination while recognizing their locations and to perform various tasks. Localization technology of mobile robots for indoor environments in which global positioning system (GPS) cannot be used is under active research through indoor localization technologies. However, existing indoor localization technologies show low accuracy, and it is difficult to acquire location information in real time when the accuracy is increased.

### SUMMARY

Embodiments of the present disclosure are intended to provide a localization technique for ensuring both real-time characteristics and accuracy.

According to an aspect of the present disclosure, there is a localization system installed in a transportation device, the localization system including an inertial measurement device configured to generate inertial data by measuring inertia resulting from movement of the transportation device when the transportation device moves, an imaging device configured to generate captured images by photographing surroundings of the transportation device when the transportation device moves, and a location analysis device configured to measure a moved location of the transportation device on the basis of the inertial data and at least one of the captured images.

The location analysis device may include a front-end section, and the front-end section may include a location estimator configured to calculate at least one of travel distance information, travel direction information, and orientation information of the transportation device from the inertial data and estimate a location of the transportation device on the basis of the calculated information, a first image processor configured to extract a feature point from the captured images, and a first location corrector configured to correct the estimated location of the transportation device on the basis of the inertial data and the feature point.

The inertial data may be generated at preset first periods, the captured images may be generated at preset second periods which are longer than the first periods, and the front-end section may externally provide the corrected location information of the transportation device at the second periods while externally providing the estimated location information of the transportation device at the first periods.

The inertial data may be generated at preset first periods, the captured images may be generated at preset second periods, which are longer than the first periods, and may be stereo images including a left camera image and a right camera image, and when there is a time difference between the left camera image and the right camera image, the first image processor may correct a difference in feature point location caused by the time difference between the left camera image and the right camera image using inertial data acquired between the left camera image and the right camera image.

The first location corrector may estimate a three-dimensional (3D) feature point location at which a two-dimensional (2D) feature point of the stereo image is present in a 3D space on the basis of the travel distance information, the travel direction information, and the orientation information of the transportation device extracted from the inertial data and the 2D feature point extracted from the stereo image, calculate a re-projected 2D feature point location by re-projecting the estimated 3D feature point location on a 2D coordinate system, and correct the estimated location of the transportation device on the basis of a difference between a location of the 2D feature point extracted from the stereo image and the re-projected 2D feature point location.

The inertial data may be generated at preset first periods, the captured images may be generated at preset second periods which are longer than the first periods, and the first image processor may estimate and track a location of a feature point extracted from a captured image of an (n−1)^{th} (n is a natural number) period and changed in a captured image of an n^{th} period using inertial data acquired between the captured image of the (n−1)^{th} period and the captured image of the n^{th} period.

The location analysis device may further include a back-end section, and the back-end section may post-correct the location information of the transportation device generated by the front-end section on the basis of the captured images, the generated location information of the transportation device, and a 3D map of a zone corresponding to the generated location information of the transportation device.

The back-end section may include a map extractor configured to extract the 3D map of the zone corresponding to the generated location information of the transportation device from previously stored 3D maps, a second image processor configured to calculate 3D coordinates of each pixel in the captured images by re-projecting each pixel on a 3D coordinate system, a relationship determiner configured to determine a degree of relationship between 3D coordinates of pixels in the captured images and 3D coordinates of points in the 3D map and extract a pair of a pixel in the captured images and a point in the 3D map whose degree of relationship is a preset level or higher, and a second location corrector configured to detect a location of the transportation device at which a distance is minimized between coordinates of the pixel in the captured images and coordinates of the point in the 3D map whose degree of relationship is the preset level or higher and set the detected location of the transportation device as post-corrected location information of the transportation device.

The captured images may be stereo images including a left camera image and a right camera image, the second image processor may generate a depth image using the stereo images and calculate 3D coordinates of each pixel in the depth image by re-projecting each pixel on a 3D coordinate system, and the relationship determiner may project points in the 3D map viewed at a location corresponding to the generated location information of the transportation device on the depth image, extract 3D coordinates of pixels corresponding to the projected points in the 3D map from the depth image, and determine the degree of relationship on the basis of distances between the extracted 3D coordinates of pixels and coordinates of the points in the 3D map.

The location analysis device may include a front-end section configured to estimate a location of the transportation device on the basis of the inertial data and correct the estimated location of the transportation device on the basis of the inertial data and a feature point extracted from the captured images, and a back-end section configured to post-correct the location information of the transportation device generated by the front-end section on the basis of the captured image, the generated location information of the transportation device, and a 3D map of a zone corresponding to the generated location information of the transportation device.

The inertial data may be generated at preset first periods, the captured images may be generated at preset second periods which are longer than the first periods, and the front-end section may externally provide the corrected location information of the transportation device at the second periods while externally providing the estimated location information of the transportation device at the first periods.

According to another aspect of the present disclosure, there is a computing device including one or more processors and a memory that stores one or more programs executed by the one or more processors, the computing device including a location estimator configured to acquire inertial data resulting from movement of a transportation device, calculate at least one of travel distance information, travel direction information, and orientation information of the transportation device from the inertial data, and estimate a location of the transportation device on the basis of the calculated information;

an image processor configured to acquire a captured image of surroundings of the transportation device when the transportation device moves and extract a feature point from the captured image; and a location corrector configured to correct the estimated location of the transportation device on the basis of the inertial data and the feature point. According to still another aspect of the present disclosure, there is a computing device including one or more processors and a memory that stores one or more programs executed by the one or more processors, the computing device including a map extractor configured to acquire location information of a transportation device resulting from movement of the transportation device and extract a 3D map of a zone corresponding to the location information of the transportation device from previously stored 3D maps, an image processor configured to acquire a captured image of surroundings of the transportation device when the transportation device moves and calculate 3D coordinates of each pixel in the captured image by re-projecting each pixel on a 3D coordinate system, a relationship determiner configured to determine a degree of relationship between 3D coordinates of pixels in the captured image and 3D coordinates of points in the 3D map and extract a pair of a pixel in the captured image and a point in the 3D map whose degree of relationship is a preset level or higher, and a location corrector configured to detect a location of the transportation device at which a distance is minimized between coordinates of the pixel in the captured image and coordinates of the point in the 3D map whose degree of relationship is the preset level or higher and set the detected location of the transportation device as post-corrected location information of the transportation device.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a diagram illustrating a configuration of a localization system according to an embodiment of the present disclosure;

FIG. 2 is a block diagram illustrating a configuration of a location analysis device according to an embodiment of the present disclosure;

FIG. 3 is a view illustrating a process in which a back-end module determines the degree of relationship between a pixel in a depth image and coordinates in a three-dimensional (3D) map according to an embodiment of the present disclosure; and

FIG. 4 is a block diagram illustrating a computing environment including a computing device appropriate for use in exemplary embodiments.

### DETAILED DESCRIPTION OF EXEMPLARY EMBODIMENTS

Hereinafter, embodiments of the present disclosure will be described in detail with reference to the accompanying drawings. The following detailed description is provided to assist the reader in gaining a comprehensive understanding of the methods, apparatuses, and/or systems described herein. However, the description is only exemplary, and the present disclosure is not limited thereto.

In describing the embodiments of the present disclosure, when it is determined that a detailed description of known techniques associated with the present disclosure would unnecessarily obscure the subject matter of the present disclosure, the detailed description thereof will be omitted. Also, terms used herein are defined in consideration of the functions in the present disclosure and may be changed depending on a user, the intent of an operator, or a custom. Accordingly, the terms should be defined based on the following overall description of this specification. The terminology used herein is only for the purpose of describing embodiments of the present disclosure and is not restrictive. The singular forms “a,” “an,” and “the” are intended to include the plural forms as well, unless the context clearly indicates otherwise. It should be understood that the terms “comprises,” “comprising,” “includes,” and/or “including,” specify the presence of stated features, integers, steps, operations, elements, and/or parts or combinations thereof when used herein, but do not preclude the presence or addition of one or more other features, integers, steps, operations, elements, and/or parts or combinations thereof.

In the following description, the terms “transmission,” “communication,” “transmitting,” and “receiving” of a signal or information and other terms similar thereto include not only direct transfer of the signal or information from one element to another element but also transfer through still another element. In particular, “transmission” or “transmitting” a signal or information to an element indicates the final destination of the signal or information and does not mean the direct destination. This is the same for “receiving” of a signal or information. Also, in this specification, two or more pieces of data or information referred to as being “related” to each other mean that when one piece of data (or information) is acquired, it is possible to acquire at least a part of the other to data (or information).

The terms, such as first and second, may be used to describe various elements, but the elements should not be limited to the terms. The terms may be used for the purpose of distinguishing one element from another element. For example, a first element may be termed a second element, and similarly, a second element may be termed a first element without departing from the scope of the present disclosure.

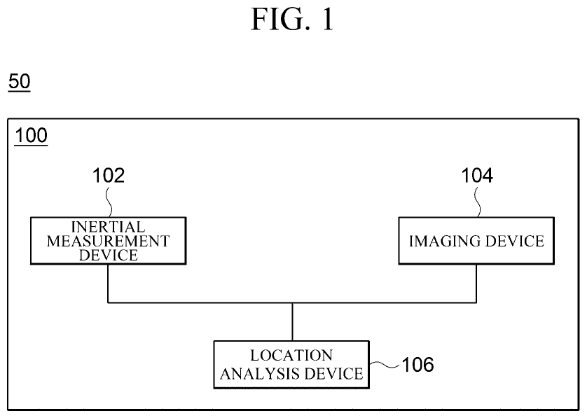

FIG. 1 is a diagram illustrating a configuration of a localization system according to an embodiment of the present disclosure. The configuration of the system shown in FIG. 1 shows functional elements which are functionally divided. The functional elements may be functionally connected to each other to perform a function according to the present disclosure, and any one or more elements may be physically integrated with each other

Referring to FIG. 1, a localization system 100 may include an inertial measurement device 102, an imaging device 104, and a location analysis device 106.

In an exemplary embodiment, the localization system 100 may be installed in a transportation device 50 (e.g., a robot, a vehicle, an airplane, or the like). The localization system 100 may exchange data with the transportation device 50 through an input/output interface (not shown). A case in which the transportation device 50 is a robot capable of self-driving will be described below as an embodiment.

The inertial measurement device 102 may measure inertia resulting from movement of the transportation device 50 and generate inertial data. The inertial measurement device 102 may generate inertial data by measuring inertia with respect to three axes which are perpendicular to each other. Here, the inertial data may include acceleration with respect to x-axis, y-axis, and z-axis and angular velocity values with respect to a roll, a pitch, and a yaw. The inertial measurement device 102 may generate inertial data at preset first periods (e.g., 0.005 seconds).

The imaging device 104 may photograph surroundings of the transportation device 50 when the transportation device 50 moves. In an exemplary embodiment, the imaging device 104 may be a stereo camera. Each of the left camera and the right camera of the stereo camera may acquire images for a time period (e.g., 0.01 seconds) within a preset margin of error. In this case, the imaging device 104 may generate stereo images by photographing surroundings of the transportation device 50. The imaging device 104 may generate stereo images at preset second periods. Here, the second periods may be longer than the first periods. For example, the second periods may be 0.1 seconds. However, the second periods are not limited thereto and may be provided so that the imaging device 104 may generate a three-dimensional (3D) image by photographing surroundings of the transportation device 50.

The location analysis device 106 may generate location information by measuring the location of the transportation device 50 on the basis of the inertial data of the inertial measurement device 102 and a captured image (an embodiment in which the captured image is a stereo image will be described below) of the imaging device 104.

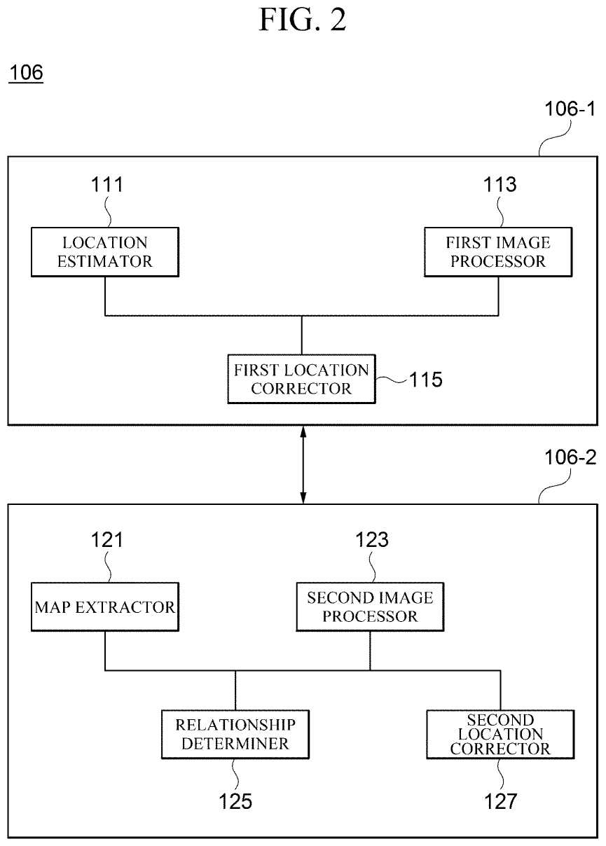

FIG. 2 is a block diagram illustrating a configuration of a location analysis device according to an embodiment of the present disclosure. Referring to FIG. 2, the location analysis device 106 may include a front-end module 106-1 and a back-end module 106-2.

The front-end module 106-1 is intended for providing information on the location of the transportation device 50 as quickly as possible. The front-end module 106-1 may generate the location information of the transportation device 50 by processing inertial data and the data of a stereo image in real time. The back-end module 106-2 may generate more accurate location information by correcting the location information of the transportation device 50 which is rapidly generated by the front-end module 106-1. In other words, the front-end module 106-1 is intended for rapidly providing the location information of the transportation device 50 by operating in real time, and the back-end module 106-2 is intended for increasing accuracy in the location information of the transportation device 50 by operating in non-real time. Here, the front-end module 106-1 and the back-end module 106-2 may operate in parallel independently of each other. In this case, it is possible to ensure both the real-time characteristics and accuracy of the location information of the transportation device 50.

The front-end module 106-1 may include a location estimator 111, a first image processor 113, and a first location corrector 115. The front-end module 106-1 may measure the relative location of the transportation device 50 in relation to a previous location of the transportation device 50 when the transportation device 50 has moved.

Also, in an embodiment, the location estimator 111, the first image processor 113, and the first location corrector 115 may be implemented using one or more devices which are physically divided or implemented by one or more processors or a combination of one or more processors and software. Unlike the example shown in the drawing, the location estimator 111, the first image processor 113, and the first location corrector 115 may not be clearly divided in terms of detailed operation.

The location estimator 111 may estimate a moved location of the transportation device 50 on the basis of inertial data of the inertial measurement device 102. The location estimator 111 may extract travel distance information and orientation information of the transportation device 50 from the inertial data and estimate the location of the transportation device 50 on the basis of the extracted travel distance information and orientation information.

Here, the location estimator 111 may calculate a travel direction and the travel distance of the transportation device 50 using acceleration values with respect to x-axis, y-axis, and z-axis in the inertial data. Also, the location estimator 111 may calculate the orientation of the transportation device 50 using angular velocity values with respect to a roll, a pitch, and a yaw in the inertial data. The location estimator 111 may estimate the moved location of the transportation device 50 on the basis of a preset initial location of the transportation device 50, the travel direction and travel distance of the transportation device 50, and the orientation of the transportation device 50. The location estimator 111 may externally provide (e.g., to the transportation device 50 or an external device or the like communicating with the transportation device 50) the estimated location information of the transportation device 50. In this case, the localization system 100 provides the location information (the estimated location information) of the transportation device 50 at every first period.

The first image processor 113 may extract feature points (two-dimensional (2D) feature points) from a stereo image of the imaging device 104. The first image processor 113 may extract feature points from each of a left camera image and a right camera image of the stereo image. Here, when there is a time difference between the left camera image and the right camera image, the first image processor 13 may extract feature points using inertial data acquired between the left camera image and the right camera image.

In other words, the first image processor 113 may correct a location difference between feature points caused by the time difference between the left camera image and the right camera image using the inertial data acquired therebetween. In an exemplary embodiment, when the left camera image is acquired 0.01 seconds later than the right camera image, a feature point location at which a feature point extracted from the right camera image will be present in the left camera image may be estimated using the inertial data (periods of generating inertial data are 0.005 seconds shorter than 0.01 seconds) acquired between the left camera image and the right camera image.

Also, when a certain feature point is extracted from a stereo image of an (n−1)^{th} (n is a natural number) period, the first image processor 113 may estimate and track the location of the feature point in a stereo image of an n^{th} period using inertial data. In other words, a changed location of the feature point extracted from the stereo image of the (n−1)^{th} period may be estimated and tracked in the stereo image of the n^{th} period using inertial data acquired between the stereo image of the (n−1)^{th} period and the stereo image of the n^{th} period.

As such, inertial data is used to extract feature points between a left camera image and a right camera image of the same period and between stereo images of adjacent periods so that feature point extraction performance may be improved as compared with a case in which only the images are used.

The first image processor 113 may continuously track feature points in stereo images of a preset number of previous periods (e.g., stereo image of ten previous periods). For example, the first image processor 113 may extract each feature point from stereo images of (n−10)^{th} period to (n−1)^{th} period and track the location of each extracted feature point in a stereo image of the next period.

The first location corrector 115 may correct the location of the transportation device 50 estimated by the location estimator 111 using inertial data and the feature points (2D feature points) extracted by the first image processor 113. The corrected location information may be externally provided (e.g., to the transportation device 50 or an external device or the like communicating with the transportation device 50).

Specifically, the first location corrector 115 may estimate a point at which a certain 2D feature point of a stereo image is present in an actual 3D space (i.e., a 3D feature point location) on the basis of the travel direction, the travel distance, and the orientation information of the transportation device 50 calculated from the inertial data and the 2D feature points extracted from the stereo image (2D feature points tracked and extracted from the preset number of stereo images of previous periods). For example, the first location corrector 115 may estimate a point at which a 2D feature point tracked through stereo images of 10 previous periods is present in the actual 3D space. In an exemplary embodiment, the first location corrector 115 may estimate a 3D feature point location using inverse depth least square Gauss Newton optimization, but a 3D feature point location estimation method is not limited thereto.

The first location corrector 115 may two-dimensionally re-project the estimated 3D feature point location to each of a preset number of stereo images of previous periods and calculate each of re-projected 2D feature point locations. The first location corrector 115 may calculate each of differences between the 2D feature point locations extracted from the preset number of stereo images of previous periods and the re-projected 2D feature point locations. The first location corrector 115 may correct the location of the transportation device 50 estimated by the location estimator 111 on the basis of the differences between the 2D feature point locations in the preset number of stereo images of previous periods and the re-projected 2D feature point locations.

The first location corrector 115 may correct the location of the transportation device 50 estimated by the location estimator 111 in a direction in which the sum of differences between 2D feature point locations in the preset number of stereo images of previous periods and the re-projected 2D feature point locations is minimized. In an exemplary embodiment, the first location corrector 115 may correct the location of the transportation device 50 by applying the differences between the 2D feature point locations and the re-projected 2D feature point locations to the extended Kalman filter.

The first location corrector 115 may externally provide (e.g., to the transportation device 50 or an external device or the like communicating with the transportation device 50) the corrected location information of the transportation device 50. In this case, the localization system 100 may provide the corrected location information of the transportation device 50 at second periods which are generation periods of stereo images.

Meanwhile, the first location corrector 115 may execute a location correction algorithm using only feature points satisfying a preset condition among the 2D feature points extracted from the preset number of stereo images of previous periods. In an exemplary embodiment, the first location corrector 115 may execute a location correction algorithm using only feature points which are tracked a preset number of times or more among the 2D feature points extracted from the preset number of stereo images of previous periods (e.g., feature points having been tracked five times or more in stereo images of 10 previous periods). In other words, when there are too many 2D feature points extracted from stereo images, location correction takes time, and it is not possible to ensure real-time characteristics. For this reason, a location correction algorithm may be executed using only feature points satisfying the preset condition.

Also, when the number of 2D feature points satisfying the preset condition among the 2D feature points extracted from the preset number of stereo images of previous periods is a preset reference number or less, the first location corrector 115 does not execute a location correction algorithm so that location correction may not be performed inaccurately.

Here, the front-end module 106-1 may provide the location information of the transportation device 50 estimated using inertial data at the first periods and also provide the location information of the transportation device 50 corrected using stereo images at time points corresponding to the second periods.

The back-end module 106-2 may include a map extractor 121, a second image processor 123, a relationship determiner 125, and a second location corrector 127. The back-end module 106-2 may measure the absolute location of the transportation device 50 in a space in which the transportation device 50 is present (i.e., the absolute location of the transportation device 50 in a 3D map space described below). The back-end module 106-2 may post-correct the location information of the transportation device 50 generated by the front-end module 106-1 (i.e., the location information estimated by the location estimator 111 or the location information corrected by the first location corrector 115) using the 3D map of a corresponding zone.

Also, in an embodiment, the map extractor 121, the second image processor 123, the relationship determiner 125, and the second location corrector 127 may be implemented using one or more devices which are physically divided or implemented by one or more processors or a combination of one or more processors and software. Unlike the example shown in the drawing, the map extractor 121, the second image processor 123, the relationship determiner 125, and the second location corrector 127 may not be clearly divided in terms of detailed operation.

The map extractor 121 may extract a 3D map of a zone corresponding to the location information of the transportation device 50 generated by the front-end module 106-1. The map extractor 121 may extract the 3D map from a map database (not shown). 3D maps may be stored in the map database (not shown) according to zones of a certain size. In the 3D map, the coordinates of the center point of a corresponding zone may be stored as a key value with points included in the corresponding zone.

Specifically, when the location information of the transportation device 50 is received from the front-end module 106-1, the map extractor 121 may search for key (i.e., a key representing each zone) values (i.e., coordinate values) present in a certain radius to on the basis of the location information and extract a 3D map corresponding to a found key. Since the 3D map of a zone corresponding to the location information of the transportation device 50 measured by the front-end module 106-1 is extracted, it is possible to load only local map data which is actually used for locating. Accordingly, the amount of calculation for the comparison of an image and a map which will be described below can be reduced.

The second image processor 123 may calculate 3D coordinates of each pixel by re-projecting each pixel in a captured image of the imaging device 104 on a 3D coordinate system. The 3D coordinates of each pixel in the captured image may be used to determine the degree of relationship with points in the 3D map extracted by the map extractor 121.

Meanwhile, when the captured image of the imaging device 104 is a stereo image (including a left camera image and a right camera image), the second image processor 123 may generate a depth image using the stereo image. Then, the second image processor 123 may calculate the 3D coordinates of each pixel in the depth image by re-projecting each pixel on a 3D coordinate system.

The relationship determiner 125 may determine the degree of relationship between the 3D coordinates of a pixel in the depth image generated using the stereo image (the coordinates acquired by re-projecting the pixel on the 3D coordinate system) and a point in the 3D map and extract a pair of a pixel in the depth image and a point in the 3D map which have the degree of relationship of a preset level or higher.

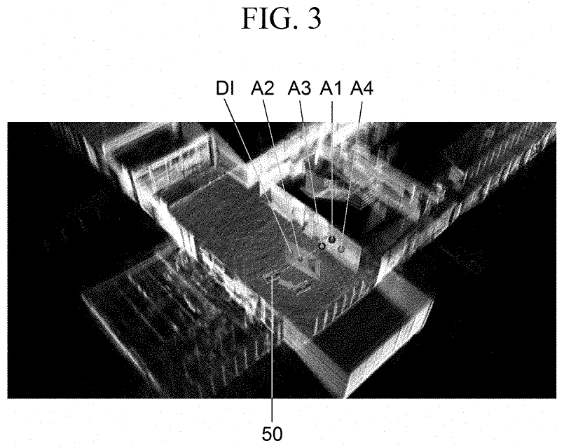

FIG. 3 is a view illustrating a process in which a back-end module determines the degree of relationship between a pixel in a depth image and coordinates in a 3D map according to an embodiment of the present disclosure.

Referring to FIG. 3, the relationship determiner 125 may project a point A1 in a to 3D map, which is viewed at a location corresponding to the location information of the transportation device 50 generated by the front-end module 106-1, on a depth image DI. In the depth image DI, the relationship determiner 125 may detect a pixel A2 corresponding to a point in the 3D map projected on the depth image DI. In other words, when the point A1 in the 3D map is projected on the depth image DI, the pixel A2 corresponds to 2D coordinates in the depth image DI.

The relationship determiner 125 may re-project the pixel A2 on a 3D coordinate system and extract re-projected 3D coordinates (i.e., 3D coordinates of the pixel) A3. The relationship determiner 125 may determine the degree of relationship between a corresponding pixel in a stereo image and a point in the 3D map on the basis of the distance between the 3D coordinates A3 of the pixel and the coordinates A1 of the point in the 3D map.

Here, the shorter the distance between the 3D coordinates of the pixel and the coordinates of the point in the 3D map, the greater the degree of relationship, and the longer the distance between the 3D coordinates of the pixel and the coordinates of the point in the 3D map, the less the degree of relationship. The relationship determiner 125 may extract a pair of a pixel in a depth image and a point in the 3D map which have the degree of relationship of the preset level or higher.

The second location corrector 127 may post-correct the location information of the transportation device 50 regarding the pair of a pixel in the depth image and a point in the 3D map which have the degree of relationship of the preset level or higher in a direction in which the distance between the 3D coordinates of the pixel of the depth image and the coordinates of the point in the 3D map in a depth direction (e.g., a z-axis direction) is minimized.

Specifically, the second location corrector 127 may detect the location of the transportation device 50 at which the distance between the 3D coordinates of the pixel in the depth image and the coordinates of the point in the 3D map in the depth direction (e.g., the z-axis direction) is minimized while adjusting the location information of the transportation device 50 through a well-known optimization algorithm. The second location corrector 127 may determine the detected location of the transportation device 50 as post-corrected location information of the location of the transportation device 50 measured by the front-end module 106-1.

In other words, when 3D coordinates A3 of a pixel actually correspond to a point A4 in a 3D map of FIG. 3, the second location corrector 127 may move the location of the transportation device 50 in an arrow direction so that the 3D coordinates A3 of the pixel may correspond to the point A4 in the 3D map in a simulation and may determine the moved location as the post-corrected location of the transportation device 50.

The back-end module 106-2 may transmit the post-corrected location information of the transportation device 50 to the front-end module 106-1. Then, the front-end module 106-1 may use the post-corrected location information of the transportation device 50.

In the embodiments of the present disclosure, the location of the transportation device 50 is post-corrected using pieces of data having different attributes, that is, a depth image (i.e., a 2D image including depth information) generated from stereo images and a 3D map, so that the localization system may operate robustly even when an actual environment becomes different from a 3D map built in advance. In other words, when an object which does not exist in a 3D map is present in an actual environment, the object is excluded from pairing based on the degree of relationship by comparing the 3D map with a depth image. Consequently, even when an actual environment becomes different from a 3D map, the localization system may robustly operate.

In this specification, a module refers to a combination of hardware for carrying out the technical spirit of the present disclosure and software for operating the hardware. For example, the “module” may mean a logical unit of a certain code and hardware resources for executing the certain code and does not necessarily mean a physically connected code or one type of hardware.

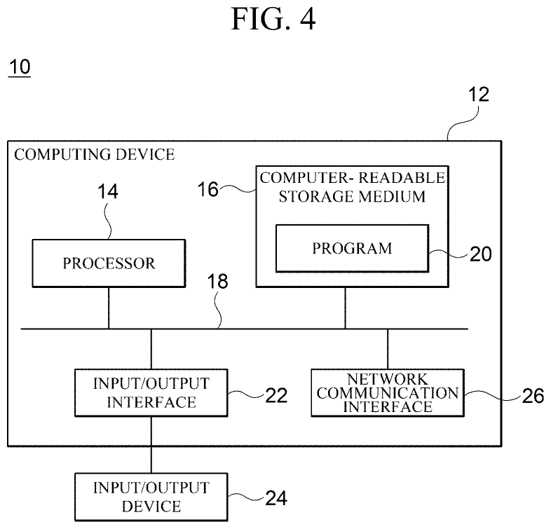

FIG. 4 is a block diagram illustrating a computing environment 10 including a computing device appropriate for use in exemplary embodiments. In the shown embodiment, each component may have functions and capabilities other than those described below, and additional components other than those described below may be included.

The shown computing environment 10 includes a computing device 12. In an embodiment, the computing device 12 may be the inertial measurement device 102. Also, the computing device 12 may be the imaging device 104. Also, the computing device 12 may be the location analysis device 106. Also, the computing device 12 may be the front-end module 106-1. Also, the computing device 12 may be the back-end module 106-2. Also, the computing device 12 may be the transportation device 50.

The computing device 12 may include at least one processor 14, a computer-readable storage medium 16, and a communication bus 18. The processor 14 may cause the computing device 12 to operate according to the above-described exemplary embodiments. For example, the processor 14 may execute one or more programs stored in the computer-readable storage medium 16. The one or more programs may include one or more computer-executable instructions, which may be configured to cause, when executed by the processor 14, the computing device 12 to perform operations according to the exemplary embodiments.

The computer-readable storage medium 16 stores computer-executable instructions, program codes, program data, and/or other suitable forms of information. Programs 20 stored in the computer-readable storage medium 16 include a set of instructions executable by the processor 14. In an embodiment, the computer-readable storage medium 16 may be a memory (a volatile memory, such as a random access memory, a non-volatile memory, or a suitable combination thereof), one or more magnetic disk storage devices, optical disk storage devices, flash memory devices, other forms of storage media accessible by the computing device 12 and capable of storing desired information, or suitable combinations thereof.

The communication bus 18 interconnects various components of the computing device 12 including the processor 14 and the computer-readable storage medium 16.

The computing device 12 may also include at least one input/output interface 22 which provides an interface for at least one input/output device 24 and at least one network communication interface 26. The input/output interface 22 and the network communication interface 26 are connected to the communication bus 18. The input/output device 24 may be connected to other components of the computing device 12 through the input/output interface 22. The exemplary input/output device 24 may include input devices, such as a pointing device (a mouse, a trackpad, or the like), a keyboard, a touch input device (a touch pad, a touch screen, or the like), a voice or sound input device, various types of sensor devices, and/or an imaging device, and/or output devices, such as a display device, a printer, a speaker, and/or a network card. The exemplary input/output device 24 may be included in the computing device 12 as a component constituting the computing device 12 or may be connected to the computing device 12 as a separate device distinct from the computing device 12. The exemplary input/output device 24 may include a controller for operating a transportation device whose location information is acquired.

According to the embodiments of the present disclosure, it is possible to increase accuracy in the location of a transportation device by providing the location information of the transportation device through a front-end module and post-correcting the location information of the transportation device through a back-end module. In other words, it is possible to ensure both the real-time characteristics and accuracy of the location information of the transportation device.

Also, since the location of a transportation device is post-corrected using pieces of data having different attributes, that is, a depth image (i.e., a 2D image including depth information) generated from stereo images and a 3D map, the localization system can operate robustly even when an actual environment becomes different from a 3D map built in advance.

Although the exemplary embodiments of the present disclosure have been described in detail, it should be understood by those skilled in the art that various modifications can be made to the above-described embodiments without departing from the scope of the present disclosure. Therefore, the scope of the present disclosure is not limited to the above-described embodiments and should be determined by the following claims and their equivalents.

What is claimed is:

1. A localization system installed in a transportation device, the localization system comprising:
an inertial measurement device configured to generate inertial data by measuring inertia resulting from movement of the transportation device when the transportation device moves;
an imaging device configured to generate captured images by photographing surroundings of the transportation device when the transportation device moves; and
a location analysis device configured to measure a moved location of the transportation device on the basis of the inertial data and at least one of the captured images.

2. The localization system of claim 1, wherein the location analysis device comprises a front-end section; and
the front-end section comprises:
a location estimator configured to calculate at least one of travel distance information, travel direction information, and orientation information of the transportation device from the inertial data and estimate a location of the transportation device on the basis of the calculated information;
a first image processor configured to extract a feature point from the captured images; and
a first location corrector configured to correct the estimated location of the transportation device on the basis of the inertial data and the feature point.

3. The localization system of claim 2, wherein the inertial data is generated at preset first periods;
the captured images are generated at preset second periods which are longer than the first periods; and
the front-end section externally provides the corrected location information of the transportation device at the second periods while externally providing the estimated location information of the transportation device at the first periods.

4. The localization system of claim 2, wherein the inertial data is generated at to preset first periods;
the captured images are generated at preset second periods, which are longer than the first periods, and are stereo images including a left camera image and a right camera image; and
when there is a time difference between the left camera image and the right camera image, the first image processor corrects a difference in feature point location caused by the time difference between the left camera image and the right camera image using inertial data acquired between the left camera image and the right camera image.

5. The localization system of claim 4, wherein the first location corrector is configured to:
estimate a three-dimensional (3D) feature point location at which a two-dimensional (2D) feature point of the stereo images is present in a 3D space on the basis of the travel distance information, the travel direction information, and the orientation information of the transportation device extracted from the inertial data and the 2D feature point extracted from the stereo images;
calculate a re-projected 2D feature point location by re-projecting the estimated 3D feature point location on a 2D coordinate system; and
correct the estimated location of the transportation device on the basis of a difference between locations of the 2D feature point extracted from the stereo images and the re-projected 2D feature point location.

6. The localization system of claim 2, wherein the inertial data is generated at preset first periods;
the captured images are generated at preset second periods which are longer than the first periods; and
the first image processor estimates and tracks a location of a feature point extracted from a captured image of an (n−1)^{th} (n is a natural number) period and changed in a captured image of an n^{th} period using inertial data acquired between the captured image of the (n−1)^{th} period and the captured image of the n^{th} period.

7. The localization system of claim 2, wherein the location analysis device further comprises a back-end section; and
the back-end section post-corrects the location information of the transportation device generated by the front-end section on the basis of the captured images, the generated location information of the transportation device, and a three-dimensional (3D) map of a zone corresponding to the generated location information of the transportation device.

8. The localization system of claim 7, wherein the back-end section comprises:
a map extractor configured to extract the 3D map of the zone corresponding to the generated location information of the transportation device from previously stored 3D maps;
a second image processor configured to calculate 3D coordinates of each pixel in the captured images by re-projecting each pixel on a 3D coordinate system;
a relationship determiner configured to determine a degree of relationship between 3D coordinates of pixels in the captured images and 3D coordinates of points in the 3D map and extract a pair of a pixel in the captured images and a point in the 3D map whose degree of relationship is a preset level or higher; and
a second location corrector configured to detect a location of the transportation device at which a distance is minimized between coordinates of the pixel in the captured images and coordinates of the point in the 3D map whose degree of relationship is the preset level or higher and set the detected location of the transportation device as post-corrected location information of the transportation device.

9. The localization system of claim 8, wherein the captured images are stereo images including a left camera image and a right camera image;
the second image processor generates a depth image using the stereo images and calculates 3D coordinates of each pixel in the depth image by re-projecting each pixel on a 3D coordinate system; and
the relationship determiner projects points in the 3D map viewed at a location corresponding to the generated location information of the transportation device on the depth image, extracts 3D coordinates of pixels corresponding to the projected points in the 3D map from the depth image, and determines the degree of relationship on the basis of distances between the extracted 3D coordinates of pixels and coordinates of the points in the 3D map.

10. The localization system of claim 1, wherein the location analysis device comprises:
a front-end section configured to estimate a location of the transportation device on the basis of the inertial data and correct the estimated location of the transportation device on the basis of the inertial data and a feature point extracted from the captured images; and
a back-end section configured to post-correct the location information of the transportation device generated by the front-end section on the basis of the captured images, the generated location information of the transportation device, and a three-dimensional (3D) map of a zone corresponding to the generated location information of the transportation device.

11. The localization system of claim 10, wherein the inertial data is generated at preset first periods;
the captured images are generated at preset second periods which are longer than the first periods; and
the front-end section externally provides the corrected location information of the transportation device at the second periods while externally providing the estimated location information of the transportation device at the first periods.

12. A transportation device in which the localization system of claim 1 is installed.

13. A computing device comprising one or more processors and a memory that stores one or more programs executed by the one or more processors, the computing device comprising:
a location estimator configured to acquire inertial data resulting from movement of a transportation device, calculate at least one of travel distance information, travel direction information, and orientation information of the transportation device from the inertial data, and estimate a location of the transportation device on the basis of the calculated information;
an image processor configured to acquire a captured image of surroundings of the transportation device when the transportation device moves and extract a feature point from the captured image; and
a location corrector configured to correct the estimated location of the transportation device on the basis of the inertial data and the feature point.

14. A computing device comprising one or more processors and a memory that stores one or more programs executed by the one or more processors, the computing device comprising:
a map extractor configured to acquire location information of a transportation device resulting from movement of the transportation device and extract a three-dimensional (3D) map of a zone corresponding to the location information of the transportation device from previously stored 3D maps;
an image processor configured to acquire a captured image of surroundings of the transportation device when the transportation device moves and calculate 3D coordinates of each pixel in the captured image by re-projecting each pixel in the captured image on a 3D coordinate system;
a relationship determiner configured to determine a degree of relationship between 3D coordinates of pixels in the captured image and 3D coordinates of points in the 3D map and extract a pair of a pixel in the captured image and a point in the 3D map whose degree of relationship is a preset level or higher; and
a location corrector configured to detect a location of the transportation device at which a distance is minimized between coordinates of the pixel in the captured image and coordinates of the point in the 3D map whose degree of relationship is the preset level or higher and set the detected location of the transportation device as post-corrected location information of the transportation device.
